(19) United States
(12) Patent Application Publication
(10) Pub. No.: US 2008/0261115 A1
(43) Pub. Date: Oct. 23, 2008

(54) Non-aqueous electrolyte secondary battery and positive electrode

(76) Inventors: Motoharu Saito, Osaka (JP); Katsutoshi Takeda, Osaka (JP); Hideyuki Koga, Susono-shi (JP); Hiroshi Sawada, Nisshin-shi (JP); Masahisa Fujimoto, Osaka (JP); Denis Yau Wai Yu, Osaka (JP)

Correspondence Address: KUBOVCIK & KUBOVCIK, SUITE 1105, 1215 SOUTH CLARK STREET, ARLINGTON, VA, 22202, US

(21) Appl. No.: 12/073,701

(22) Filed: Mar. 7, 2008

(30) Foreign Application Priority Data
Mar. 8, 2007 (JP) 2007-058562
Jan. 16, 2008 (JP) 2008-006720

(51) Int. Cl. H01M 4/52; H01M 4/50; H01M 4/40

(52) U.S. Cl. 429/223; 429/224

(57) ABSTRACT

A non-aqueous electrolyte secondary battery includes a positive electrode having a positive electrode mixture, a negative electrode, and a non-aqueous electrolyte. The positive electrode mixture contains as a positive electrode active material Li₁₊ₓ(Mn_{y}Ni_{z}Co_{1-y-z})₁₋ₓO₂, where 0<x<0.4, 0<y≦1, and 0≦z≦1. The positive electrode mixture has a filling density of from 2.2 g/cm³ to 3.6 g/cm³, and a film thickness of less than 50 μm.

### BACKGROUND OF THE INVENTION

1. Field of the Invention

The present invention relates to non-aqueous electrolyte secondary batteries and positive electrodes used for the non-aqueous electrolyte secondary batteries.

2. Description of Related Art

Currently, non-aqueous electrolyte secondary batteries using non-aqueous electrolytes and which perform charge-discharge operations by transferring lithium ions between positive and negative electrodes are widely used as high-energy density secondary batteries.

In this type of non-aqueous electrolyte secondary battery, the positive electrode is typically composed of a layered lithium cobalt oxide (LiCoO₂), and the negative electrode is typically composed of a material capable of intercalating and deintercalating lithium ions, such as a carbon material, metallic lithium, and a lithium alloy. The non-aqueous electrolyte typically contains an electrolyte salt such as lithium tetrafluoroborate (LiBF₄) or lithium hexafluorophosphate (LiPF₆) dissolved in an organic solvent such as ethylene carbonate or diethyl carbonate.

The use of cobalt (Co), however, leads to high manufacturing costs because Co is an exhaustible and scarce natural resource. For this reason, use of an alternative positive electrode material to lithium cobalt oxide, such as lithium manganese oxide (LiMn₂O₄) and lithium nickel oxide (LiNiO₂) has been investigated. The use of LiMn₂O₄, however, presents some problems such as insufficient discharge capacity and dissolution of manganese at a high battery temperature. On the other hand, LiNiO₂ has the problem of poorer thermal safety than LiCoO₂.

Under such circumstances, lithium-rich transition metal oxides such as represented by Li₂MnO₃ have drawn attention as high energy density positive electrode materials because they have a layered structure like LiCoO₂ and contain lithium (Li) in the transition metal layer in addition to the lithium (Li) layer and contain a large amount of Li involved in charge-discharge operations. (See, for example, C. S. Johnson et al., Electrochemistry Communications, 6(10), 1085-1091 (2004), and Y. Wu and A. Manthiram, Electrochemical and Solid-State Letters, 9(5) A221-A224, (2006).)

The lithium-rich transition metal oxides are represented by the general formula Li₁₊ₓM₁₋ₓO₂ (where M is at least one metal element selected from Co, Ni, Mn, Fe, and the like), and they yield varied working voltages and capacities depending on the type of the metal element M. This provides significant advantages. For example, the battery voltage can be freely selected by selecting the element M. In addition, a large battery capacity per unit mass can be achieved because their theoretical capacity is relatively high, from about 340 mAh/g to 460 mAh/g. Furthermore, by using manganese (Mn) as the metal element M in the general formula, the amounts of necessary rare metals, such as cobalt (Co) and nickel (Ni), can be reduced. Thus, the lithium-rich transition metal oxides are advantageous in that the manufacturing costs can be reduced significantly while high energy density can be obtained.

Nevertheless, in order to use the lithium-rich transition metal oxides as positive electrode active materials for non-aqueous electrolyte batteries, there are still problems to overcome. Particular problems include the following.

For a lithium-rich transition metal oxide, manganese (Mn) is mainly used as a transition metal. The use of manganese (Mn) tends to yield a positive electrode active material with a lower electrical conductivity and a lower diffusion rate of lithium (Li) ions than those obtained by lithium cobalt oxide (LiCoO₂) or lithium nickel oxide (LiNiO₂). Therefore, in a battery employing a lithium-rich transition metal oxide as the positive electrode active material, electrochemical polarization because of electric resistance or reaction resistance occurs especially during high rate discharge, deteriorating the discharge capacity.

To resolve this problem, If a large amount of conductive agent is added to the positive electrode active material to attempt to solve the problem, the proportion of the lithium-rich transition metal oxide in the positive electrode mixture decreases, although the electrical conductivity of the positive electrode active material may improve. As a result, the problem of poor battery capacity arises.

It is an object of the present invention to provide a non-aqueous electrolyte battery that has a high capacity and at the same time good load characteristics, and a positive electrode used for the battery.

### BRIEF SUMMARY OF THE INVENTION

The present invention provides a non-aqueous electrolyte secondary battery comprising: a positive electrode having a positive electrode mixture, a negative electrode, and a non-aqueous electrolyte, the positive electrode mixture containing as a positive electrode active material Li₁₊ₓ(Mn_{y}Ni_{z}Co_{1-y-z})₁₋ₓO₂ where 0<x<0.4, 0<y≦1, and 0≦z≦1; and the positive electrode mixture having a filling density of from 2.2 g/cm³ to 3.6 g/cm³, and a film thickness of less than 50 μm.

In the non-aqueous electrolyte secondary battery, Li₁₊ₓ(Mn_{y}Ni_{z}Co_{1-y-z}) where 0<x<0.4, 0<y≦1, and 0≦z≦1 is used as a positive electrode active material. This means that the amount of lithium involved in the charge-discharge reactions is large, so a high capacity can be obtained. In addition, the positive electrode mixture has a filling density of from 2.2 g/cm³ to 3.6 g/cm³, and a film thickness of less than 50 μm. This prevents an increase of the electrical resistance in the positive electrode and a deterioration of the diffusion rate of lithium ions. Therefore, high rate discharge capability improves. As a result, excellent load characteristics can be obtained while at the same time high capacity can be ensured.

It is preferable that the film thickness of the positive electrode active material be 40 μm or less. In this case, it is possible to sufficiently inhibit an increase of the electrical resistance of the positive electrode and a deterioration of the diffusion rate of lithium ions. Therefore, high rate discharge capability improves further.

It is preferable that the film thickness of the positive electrode active material be 20 μm or greater. This serves to ensure a sufficiently high capacity.

It is preferable that the positive electrode active material be Li_{1.20}Mn_{0.54}Ni_{0.13}Cu_{0.13}O₂. In this case, the load characteristics are improved sufficiently while at the same time high capacity is ensured.

The present invention also provides a positive electrode comprising: a positive electrode mixture, the positive electrode mixture containing as a positive electrode active material Li₁₊ₓ(Mn_{y}NiₓCo_{1-y-x})₁₋ₓO₂, where 0<x<0.4, 0<y≦1, and 0≦z≦1; and the positive electrode mixture having a filling density of from 2.2 g/cm³ to 3.6 g/cm³, and a film thickness of less than 50 μm.

In a non-aqueous electrolyte secondary battery using the above-described positive electrode, Li₁₋ₓ(Mn_{y}Ni_{z}Co_{1-y-z})₁₋ₓO₂, where 0−x<0.4, 0<y≦1, and 0≦z≦1 is used as a positive electrode active material. Thereby, a high capacity can be obtained. In addition, the positive electrode mixture has a filling density of from 2.2 g/cm³ to 3.6 g/cm³, and a film thickness of less than 50 μm. This prevents an increase of the electrical resistance in the positive electrode and a deterioration of the diffusion rate of lithium ions. Therefore, high rate discharge capability improves. As a result, excellent load characteristics can be obtained while at the same time high capacity can be ensured.

The present invention makes available a non-aqueous electrolyte battery that has a high capacity and at the same time good load characteristics.

### BRIEF DESCRIPTION OF THE DRAWINGS

FIG. 1 is a schematic drawing illustrating a test cell of a non-aqueous electrolyte secondary battery according to one embodiment of the present invention;

FIG. 2 is a graph illustrating the relationship between discharge capacity density versus discharge rate for the test cells of Examples 1 to 3 and Comparative Examples 1 and 2; and

FIG. 3 is a graph illustrating the relationship between discharge capacity density versus discharge rate for the test cell of Comparative Example 3.

### DETAILED DESCRIPTION OF THE INVENTION

Hereinbelow, a manufacturing method of the non-aqueous electrolyte secondary battery and the positive electrode according to one embodiment of the present invention will be described in detail with reference to the drawings.

It should be noted that the types of materials and various parameters, including thickness of the materials, concentrations, and so forth, are not limited to those described in the following description, but may be determined as appropriate.

(1) Positive Electrode

The positive electrode comprises a positive electrode mixture and a positive electrode current collector. The positive electrode current collector is made of, for example, a metal foil such as an aluminum foil.

The positive electrode mixture contains a positive electrode active material, a conductive agent, and a binder agent (binder). Li₁₊ₓ(Mn_{y}Ni_{z}Co_{1-y-z})₁₋ₓO₂ (where 0<x<0.4, 0<y≦1, and 0≦z≦1) is used as the positive electrode active material. The absolute specific gravity of the Li₁₊ₓ(Mn_{y}Ni_{z}Co_{1-y-z})₁₋ₓO₂ (where 0<x<0.4, 0<y≦1, and 0≦z≦1) is from 4.2 g/cm³ to 4.5 g/cm³.

The filling density of the positive electrode mixture is from 2.2 g/cm³ to 3.6 g/cm³. The film thickness of the positive electrode mixture is 50 μm.

It is generally desirable that the filling density of the positive electrode mixture be as high as possible because the volumetric energy density of the battery becomes higher. However, if the filling density of the positive electrode mixture is too high, the impregnation capability with electrolyte solution becomes poor and consequently the battery performance becomes rather poor. For this reason, it is preferable that the upper limit of the filling density be about 76% to 80% of the absolute specific gravity that is equivalent to the filling density of the positive electrode mixture using LiCoO₂ (which is 3.8 g/cm³ to 4.0 g/cm³). Note that the absolute specific gravity of LiCoO₂ is 5 g/cm³. In addition, it is preferable that the lower limit of the filling density for Li_{1.20}Mn_{0.54}Ni_{0.13}CO_{0.13}O₂ (discharge capacity density 259.8 mAh/g) used in the present embodiment be 2.2 g/cm³, which can result in a higher discharge capacity density than that obtained by LiCoO₂, the volumetric capacity density of which is 570 mAh/cm³ (discharge capacity density 150 mAh/g×3.8 g/cm³).

From the foregoing viewpoint, it is desirable that the positive electrode mixture that uses Li₁₊ₓ(Mn_{y}Ni_{z}Co_{1-y-z})₁₋ₓO₂ (where 0<x<0.4, 0<y≦1, and 0≦z≦1), which has an absolute specific gravity of from 4.2 g/cm³ to 4.5 g/cm³, has a filling density of from 2.2 g/cm³ to 3.6 g/cm³.

It is desirable that the film thickness of the positive electrode mixture be as large as possible in order to increase the energy density of the secondary battery. However, if the film thickness of the positive electrode mixture is too large, the impregnation capability with electrolyte solution becomes poor, degrading the diffusion rate of lithium ions (Li⁺). Consequently, the discharge capacity deteriorates especially during high rate discharge. In the present embodiment, the positive electrode mixture has a film thickness of less than 50 μm. Therefore, the impregnation capability with electrolyte solution is good, and the discharge capacity density during high rate discharge improves. It is more preferable that the film thickness of the positive electrode mixture be 40 μm or less. As a result, the impregnation capability with electrolyte solution is enhanced further, and the discharge capacity during high rate discharge is improved further.

It is preferable that the film thickness of the positive electrode active material be 20 μm or greater. This serves to ensure a sufficiently high capacity.

It is particularly desirable to use Li_{1.20}Mn_{0.54}Ni_{0.13}CO_{0.13}O₂ as the positive electrode active material. The secondary battery using Li_{1.20}Mn_{0.54}Ni_{0.13}CO_{0.13}O₂ as the positive electrode active material shows a discharge capacity density of about 260 mAh/g at a discharge rate of 0.05It and therefore has a high capacity, but it also shows a high current value during high rate discharge. For this reason, it is feared that the battery may show a poor discharge capacity density during high rate discharge. However, since the positive electrode mixture has a filling density of from 2.2 g/cm³ to 3.6 g/cm³ and at the same time the positive electrode mixture has a film thickness of less than 50 μm in the present embodiment, it is possible to prevent an increase in the electrical resistance of the positive electrode and a deterioration in the diffusion rate of lithium ions. Therefore, the high rate discharge capability improves while ensuring a higher capacity.

It is preferable that the content of manganese (Mn) be greater than the content of each of cobalt (Co) and nickel (Ni), as the transition metals in the positive electrode active material. Manganese is more abundant and less costly than cobalt (Co) and nickel (Ni). Thus, cost reduction of the non-aqueous electrolyte secondary battery can be achieved.

It is not particularly necessary to add a conductive agent to the positive electrode mixture containing the above-described positive electrode active material when the positive electrode mixture contains a positive electrode active material with good conductivity, but when using a positive electrode active material with low conductivity, it is preferable to add a conductive agent.

Any material having electrical conductivity may be used as the conductive agent. At least one substance among oxides, carbides, nitrides and carbon materials that have particularly good conductivity may be used.

Examples of the oxides with good conductivity include tin oxide and oxidized indium. Examples of the carbides with good conductivity include titanium carbide (TiC), tantalum carbide (TaC), niobium carbide (NbC), zirconium carbide (ZrC), and tungsten carbide (WC).

Examples of the nitrides with good conductivity include titanium nitride (TiN), tantalum nitride (TaN), niobium nitride (NbN), and tungsten nitride (WN). Examples of the carbon materials with good conductivity include Ketjen Black, acetylene black, and graphite.

When the amount of conductive agent is small, the conductivity of the positive electrode mixture cannot be enhanced sufficiently. On the other hand, when the amount of conductive agent is too large, a high density cannot be obtained because the relative proportion of the positive electrode active material contained in the positive electrode mixture becomes small. For this reason, the amount of conductive agent should be from 0 weight % to 30 weight % with respect to the total amount of the positive electrode mixture, preferably from 0 weight % to 20 weight %, and more preferably from 0 weight % to 10 weight %.

Examples of the binder agent to be added when preparing the positive electrode mixture include polytetrafluoroethylene, polyvinylidene fluoride, polyethylene oxide, polyvinyl acetate, polymethacrylate, polyacrylate, polyacrylonitrile, polyvinyl alcohol, styrene-butadiene rubber, and carboxymethylcellulose, either alone or in combination.

When the amount of the binder agent added is too large, a high energy density cannot be obtained because the relative proportion of the positive electrode active material contained in the positive electrode mixture becomes small. For this reason, the amount of the conductive agent added should be from 0 weight % to 30 weight % with respect to the total amount of the positive electrode mixture, preferably from 0 weight % to 20 weight %, and more preferably from 0 weight % to 10 weight %.

In the present embodiment, the amounts of conductive agent and binder agent are determined so that the filling density of the positive electrode mixture will be from 2.2 g/cm³ to 3.6 g/cm³, as described above.

(2) Non-Aqueous Electrolyte

The non-aqueous electrolyte may be prepared by dissolving an electrolyte salt in a non-aqueous solvent.

Examples of the non-aqueous solvent include non-aqueous solvents commonly used for batteries, such as cyclic carbonic esters, chain carbonic esters, esters, cyclic ethers, chain ethers, nitriles, amides, and combinations thereof.

Examples of the cyclic carbonic esters include ethylene carbonate, propylene carbonate and butylene carbonate. It is also possible to use a cyclic carbonic ester in which part or all of the hydrogen groups of the just-mentioned cyclic carbonic esters is/are fluorinated, such as trifluoropropylene carbonate and fluoroethylene carbonate.

Examples of the chain carbonic esters include dimethyl carbonate, ethyl methyl carbonate, diethyl carbonate, methyl propyl carbonate, ethyl propyl carbonate, and methyl isopropyl carbonate. It is also possible to use a chain carbonic ester in which part or all of the hydrogen groups of one of the foregoing chain carbonic esters is/are fluorinated.

Examples of the esters include methyl acetate, ethyl acetate, propyl acetate, methyl propionate, ethyl propionate, and γ-butyrolactone. Examples of the cyclic ethers include 1,3-dioxolane, 4-methyl-1,3-dioxolane, tetrahydrofuran, 2-methyltetrahydrofuran, propylene oxide, 1,2-butylene oxide, 1,4-dioxane, 1,3,5-trioxane, furan, 2-methylfuran, 1,8-cineol, and crown ether.

Examples of the chain ethers include 1,2-dimethoxyethane, diethyl ether, dipropyl ether, diisopropyl ether, dibutyl ether, dihexyl ether, ethyl vinyl ether, butyl vinyl ether, methyl phenyl ether, ethyl phenyl ether, butylphenyl ether, pentylphenyl ether, methoxytoluene, benzyl ethyl ether, diphenyl ether, dibenzyl ether, o-dimethoxybenzene, 1,2-diethoxyethane, 1,2-dibutoxyethane, diethylene glycol dimethyl ether, diethylene glycol diethyl ether, diethylene glycol dibutyl ether, 1,1-dimethoxymethane, 1,1-diethoxyethane, triethylene glycol dimethyl ether, and tetraethylene glycol dimethyl ether.

Examples of the nitriles include acetonitrile, and examples of the amides include dimethylformamide.

At least one substance selected from the foregoing examples may be used.

In the present embodiment, it is possible to use any electrolyte salt that is commonly used as an electrolyte salt in conventional non-aqueous electrolyte secondary batteries.

Specific examples of the electrolyte salt include lithium hexafluorophosphate (LiPF₆), lithium tetrafluoroborate (LiBF₄), LiCF₃SO₃, LiC₄F₉SO₃, LiN(CF₃SO₂)₂, LiN(C₂F₅SO₂)₂, LiAsF₆, and lithium difluoro(oxalato)borate. These electrolyte salts may be used alone or in combination.

The present embodiment employs a non-aqueous electrolyte in which lithium hexafluorophosphate as an electrolyte salt is added at a concentration of 1 mol/L to a mixed non-aqueous solvent of 30:70 volume ratio of ethylene carbonate and diethyl carbonate.

(4) Negative Electrode

The present embodiment employs a material capable of intercalating and deintercalating lithium ions as the negative electrode. Examples of such a material include metallic lithium, lithium alloys, carbon materials such as graphite, and silicon (Si).

(4) Preparation of Non-aqueous Electrolyte Secondary Battery

A method of preparing a non-aqueous electrolyte secondary battery using the positive electrode, the negative electrode, and the non-aqueous electrolyte will be described below. Herein, a method of preparing a test cell having a positive electrode (working electrode), a negative electrode (counter electrode), and a reference electrode will be described.

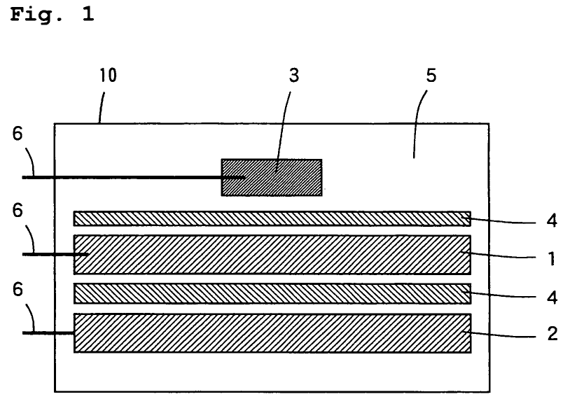

FIG. 1 is a schematic illustrative drawing illustrating a test cell of a non-aqueous electrolyte secondary battery according to the present embodiment.

In an inert atmosphere, a lead wire 6 is attached to the positive electrode 1, and likewise, a lead wire 6 is attached to the negative electrode 2 made of metallic lithium, as illustrated in FIG. 1.

Next, a separator 4 is interposed between the positive electrode 1 and the negative electrode 2, and then, the positive electrode 1, the negative electrode 2, and a reference electrode 3 are disposed in a laminate container 10. The reference electrode 3 is made of, for example, metallic lithium. Thereafter, the non-aqueous electrolyte 5 prepared in the foregoing manner is filled in the laminate container 10, to thus prepare a test cell as a non-aqueous electrolyte secondary battery. Note that a separator 4 is interposed also between the positive electrode 1 and the reference electrode 3.

(5) Advantageous Effects Obtained in the Present Embodiment

In the non-aqueous electrolyte secondary battery according to the present embodiment, Li₁₊ₓ(Mn_{y}Ni_{z}Co_{1-y-z})₁₋ₓO₂ where 0<x<0.4, 0<y≦1, and 0≦z≦1 is used as a positive electrode active material. Thereby, a high capacity can be obtained. In addition, the positive electrode mixture has a filling density of from 2.2 g/cm³ to 3.6 g/cm³, and a film thickness of less than 50 μm. This prevents an increase of the electrical resistance in the positive electrode and a deterioration of the diffusion rate of lithium ions. Therefore, high rate discharge capability improves. As a result, excellent load characteristics can be obtained while at the same time high capacity can be ensured.

In addition, when the positive electrode mixture has a film thickness of 40 μm or less, it is possible to inhibit an increase of the electrical resistance of the positive electrode and a deterioration of the diffusion rate of lithium ions sufficiently. Therefore, high rate discharge capability improves further.

Moreover, when the positive electrode active material has a film thickness of 20 μm or greater, a sufficiently high capacity can be ensured.

### EXAMPLES

### (a) Example 1

In Example 1, a positive electrode 1 was prepared in the following manner. A lithium-rich transition metal oxide Li_{1.20}Mn_{0.54}Ni_{0.13}CO_{0.13}O₂ was used as the positive electrode active material. First, lithium hydroxide (LiOH) and Mn_{0.67}Ni_{0.17}Co_{0.17}(OH)₂ prepared by coprecipitatation were mixed so as to be in a desired stoichiometric ratio, and the mixed powder was used as the starting material. The mixed powder was formed into pellets and sintered in the air at 900° C. for 24 hours. Thus, a positive electrode active material comprising Li_{1.20}Mn_{0.54}Ni_{0.13}CO_{0.13}O₂ was synthesized.

The synthesized positive electrode active material and acetylene black as a conductive agent were mixed together so that the amount of the positive electrode active material was 90 weight % with respect to the total amount of the positive electrode mixture and the amount of the conductive agent was 5 weight % with respect to the total amount of the positive electrode mixture. Thereafter, polyvinylidene fluoride (PVdF) as a binder agent was added to the resultant mixture in an amount of 5 weight % with respect to the total amount of the positive electrode mixture. Further, NMP (N-methyl-2-pyrrolidone) was added thereto in an appropriate amount and mixed to prepare a slurry. The resultant slurry was applied to an aluminum (Al) foil with a coater and dried at 110° C. using a hot plate. The resultant material was cut into a size of 2 cm×2 cm, and then pressure-rolled with rollers, to prepare a positive electrode having a film thickness of 29 μm and a filling density of 2.75 g/cm³. The resultant positive electrode was vacuum dried at 110° C., and thus, a positive electrode 1 was obtained.

Metallic lithium that was cut into a predetermined size was used as a negative electrode 2. In addition, a reference electrode 3 was also prepared by cutting metallic lithium into a predetermined size.

A non-aqueous electrolyte in which lithium hexafluorophosphate (LiPF₆) as an electrolyte salt is added at a concentration of 1.0 mol/L to a mixed non-aqueous solvent of 30:70 volume % of ethylene carbonate and diethyl carbonate was used as the non-aqueous electrolyte 5.

Using the positive electrode 1, the negative electrode 2, the reference electrode 3, and the non-aqueous electrolyte 5, a test cell of the non-aqueous electrolyte secondary battery of Example 1 was prepared in the manner described in the foregoing preferred embodiment (FIG. 1).

Specifically, in an inert atmosphere, respective lead wires 6 were attached to the positive electrode 1, the negative electrode 2, and the reference electrode 3, and the positive electrode 1, the negative electrode 2, and the reference electrode 3 with the lead wires 6 were disposed in a laminate container 10. Then, separators 4 were interposed between the positive electrode 1 and the negative electrode 2, and between the positive electrode 1 and the reference electrode 3, and thereafter, the non-aqueous electrolyte 5 was filled in a laminate container 10.

### (b) Example 2

In Example 2, the film thickness of the positive electrode mixture subsequent to the pressure-rolling was set at 32 μm by adjusting the amount of the slurry applied to the aluminum foil by the coater. A test cell was prepared in the same manner as described in Example 1, except for the film thickness of the positive electrode mixture subsequent to the pressure-rolling.

### (c) Example 3

In Example 3, the film thickness of the positive electrode mixture subsequent to the pressure-rolling was set at 40 μm by adjusting the amount of the slurry applied to the aluminum foil by the coater. A test cell was prepared in the same manner as described in Example 1, except for the film thickness of the positive electrode mixture subsequent to the pressure-rolling.

### (d) Comparative Example 1

In Comparative Example 1, the film thickness of the positive electrode mixture subsequent to the pressure-rolling was set at 50 μm by adjusting the amount of the slurry applied to the aluminum foil by the coater. A test cell was prepared in the same manner as described in Example 1, except for the film thickness of the positive electrode mixture subsequent to the pressure-rolling.

### (e) Comparative Example 2

In Comparative Example 2, the film thickness of the positive electrode mixture subsequent to the pressure-rolling was set at 60 μm by adjusting the amount of the slurry applied to the aluminum foil by the coater. A test cell was prepared in the same manner as described in Example 1, except for the film thickness of the positive electrode mixture subsequent to the pressure-rolling.

### (f) Evaluation of Load Characteristics

An evaluation of load characteristics was conducted for the test cells of the non-aqueous electrolyte secondary batteries of Examples 1 to 3 and Comparative Examples 1 and 2 under the conditions set forth in Table 1.

TABLE 1

Charge Conditions
End-charge-potential: 4.8 V (vs. Li/^{Li+})
Charge current: 0.05It
Discharge conditions
End-of-discharge potential: 2 V (vs. Li/^{Li+})
Discharge current: 2It → 1It → 0.5It → 0.2It → 0.1It → 0.05It

Each of the test cells of Examples 1 to 3 and Comparative Examples 1 and 2 was charged at a constant current of 0.05It until the potential of the positive electrode 1 reached 4.8 V versus the reference electrode 3, and thereafter discharged at a constant current of 2It until the potential of the positive electrode 1 reached 2.0 V versus the reference electrode 3.

Each of the cells was then subjected to the charge under the just-described condition and a discharge at a constant current of 1It, then the charge under the just-described condition and a discharge at a constant current of 0.5It, then the charge under the just-described condition and a discharge at a constant current of 0.2It, then the charge under the just-described condition and a discharge at a constant current of 0.1It, and the charge under the just-described condition and a discharge at a constant current of 0.05It, in that order.

The current value at which a rated capacity is completely discharged in 1 hour is referred as a rated current, which is denoted as 1.0C. This can be represented as 0.1It based on the SI unit system (International System of Unit).

The discharge capacity densities at the respective discharge rates were determined for each of the test cells of Examples 1 to 3 as well as Comparative Examples 1 and 2.

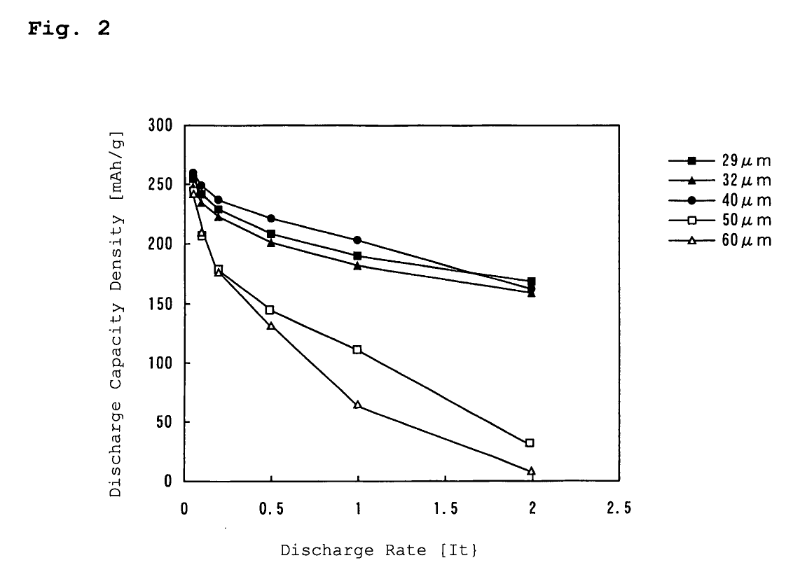

FIG. 2 is a graph illustrating the relationship between discharge capacity density versus discharge rate for the test cells of Examples 1 to 3 and Comparative Examples 1 and 2. In FIG. 2, the vertical axis represents discharge capacity density and the horizontal axis represents discharge rate.

Table 2 below shows the film thickness and filling density of the positive electrode mixture as well as the discharge capacity densities at the respective discharge rates for the test cells of Examples 1 to 3 and Comparative Examples 1 and 2.

TABLE 2

| | | | | | Comp. | Comp. |
|---|---|---|---|---|---|---|
| | | Ex. 1 | Ex. 2 | Ex. 3 | Ex. 1 | Ex. 2 |
| Positive electrode | | 29 | 32 | 40 | 50 | 60 |
| mixture film | | | | | | |
| thickness (μm) | | | | | | |
| Filling density | | 2.75 | 2.75 | 2.75 | 2.75 | 2.75 |
| (g/cm³) | | | | | | |
| Discharge | 2 | 169.2 | 161.9 | 162.8 | 32.0 | 9.0 |
| rate | 1 | 191.2 | 185.7 | 203.6 | 111.7 | 65.0 |
| (It) | 0.5 | 209.1 | 203.6 | 220.4 | 145.7 | 132.4 |
| | 0.2 | 229.2 | 224.8 | 237.3 | 180.4 | 177.4 |
| | 0.1 | 243.0 | 238.8 | 249.6 | 209.1 | 211.7 |
| | 0.05 | 255.8 | 250.0 | 259.8 | 244.5 | 242.9 |

Table 2 demonstrates the following. The test cells of Examples 1 to 3, in which the positive electrode mixture had a film thickness of less than 50 μm (29 μm, 32 μm, and 40 μm) and a filling density of 2.75 g/cm³, yielded large discharge capacity densities, greater than 160 m Ah/g, even when a high rate discharge at 2It was performed.

In contrast, the test cells of Comparative Examples 1 and 2, in which the positive electrode mixture has a film thickness of 50 μm or greater (50 μm and 60 μm) and a filling density of 2.75 g/cm³, showed very small discharge capacity densities in the high rate discharge at 2It.

Even when discharged at 0.05It to 1It, the test cells of Examples 1 to 3 yielded greater discharge capacity densities than the test cells of Comparative Examples 1 and 2.

Thus, when the positive electrode mixture has a filling density of from 2.2 g/cm³ to 3.6 g/cm³ and at the same time the positive electrode mixture has a film thickness of less than 50 μm, it is possible to prevent an increase in the electrical resistance of the positive electrode active material, L₁₊ₓ(Mn_{y}Ni_{z}Co_{1-y-z})₁₋ₓO₂ (where 0<x<0.4, 0<y≦1, and 0≦z≦1), and a deterioration of the diffusion rate of lithium ions. As a result, it becomes possible to obtain a positive electrode that achieves excellent load characteristics and at the same time ensures high capacity.

### (a) Comparative Example 3

In Comparative Example 3, 5 types of test cells with positive electrode mixtures having different film thicknesses from one another subsequent to the pressure-rolling were prepared, using a positive electrode active material made of lithium iron phosphate (LiFePO₄). The film thicknesses of the positive electrode mixtures subsequent to the pressure-rolling were set at 14 μm, 23.5 μm, 43.7 μm, 66 μm, and 93.5 μm. The mixture ratio of the positive electrode active material, the conductive agent, and the binder agent was 90:5:3. Except for the just-described points, the test cells were prepared in the same fabricating method as used for Examples 1 to 3 and Comparative Examples 1 and 2.

### (h) Evaluation of Load Characteristics of Comparative Example 3

An evaluation of load characteristics was conducted for the test cells of Comparative Example 3 under the following conditions.

Each of the test cells was charged at a constant current of 0.1It until the potential of the positive electrode 1 reached 4.5 V versus the reference electrode 3, and thereafter discharged at a constant current of 2It until the potential of the positive electrode 1 reached 2.0 V versus the reference electrode 3.

Each of the cells was then subjected to the charge under the just-described condition and a discharge at a constant current of 1It, then the charge under the just-described condition and a discharge at a constant current of 0.5It, then the charge under the just-described condition and a discharge at a constant current of 0.2It, and then the charge under the just-described condition and a discharge at a constant current of 0.1It, in that order. It should be noted that a discharge at a constant current of 0.1It was not performed for the test cell with a positive electrode mixture having a film thickness of 14 μm and the test cell with a positive electrode mixture having a film thickness of 23.5 μm.

The discharge capacity densities at the respective discharge rates were obtained for each of the test cells of Comparative Example 3.

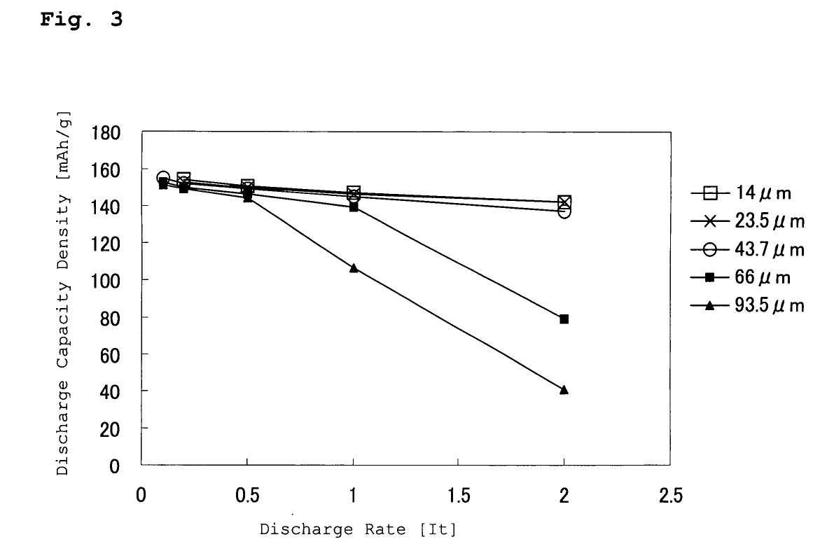

FIG. 3 is a graph illustrating the relationship between discharge capacity density versus discharge rate for the test cells of Comparative Examples 3. In FIG. 3, the vertical axis represents discharge capacity density and the horizontal axis represents discharge rate.

Table 3 below shows the film thickness and filling density of the positive electrode mixture, and the discharge capacity densities at the respective discharge rates for the test cells of Comparative Example 3.

TABLE 3

| Positive electrode | | 14 | 23.5 | 43.7 | 66 | 93.5 |
|---|---|---|---|---|---|---|
| mixture film | | | | | | |
| thickness (μm) | | | | | | |
| Filling density | | 2.58 | 2.36 | 2.32 | 2.29 | 2.25 |
| (g/cm³) | | | | | | |
| Discharge | 2 | 142 | 142 | 137 | 79 | 41 |
| rate | 1 | 147 | 146 | 144 | 139 | 107 |
| (It) | 0.5 | 150 | 150 | 149 | 146 | 144 |
| | 0.2 | 154 | 153 | 152 | 150 | 149 |
| | 0.1 | — | — | 155 | 153 | 151 |

FIG. 3 and Table 3 demonstrate the following. The cells using the positive electrode active materials comprising lithium iron phosphate showed smaller discharge capacity densities than the cells using the positive electrode active materials comprising Li₁₊ₓ (Mn_{y}Ni_{z}Co_{1-y-z})₁₋ₓO₂ where 0<x<0.4, 0<y≦1, and 0≦z≦1.

In addition, the cells using the positive electrode active material comprising lithium iron phosphate showed different characteristics from those obtained by the cells using the positive electrode active materials comprising the Li₁₊ₓ(Mn_{y}Ni_{z}CO_{1-y-z})₁₋ₓO₂.

When the discharge rate was from 0.1It to 0.5It, there was little difference in discharge capacity density between the test cells with positive electrode mixtures having a film thickness of from 14 μm to 93.5 μm. When the discharge rate was 1It, there was little difference in discharge capacity density between the test cells with positive electrode mixtures having a film thickness of from 14 μm to 66 μm.

For the test cell with the positive electrode mixture having a film thickness of 66 μm, the discharge capacity density obtained at a discharge rate of 1It was about 91% of the discharge capacity density obtained at a discharge rate of 0.1It. In other words, when the discharge rate was 1It, no significant decrease in the discharge capacity density was observed. When the discharge rate was 2It, the discharge capacity density obtained was about 52% of the discharge capacity density obtained at a discharge rate of 0.1It.

It should be noted that when lithium cobalt oxide (LiCoO₂) is used as the positive electrode active material, the discharge capacity density is 150 mAh/g. Assuming that the filling density of the positive electrode mixture is 3.8 g/cm³, the volumetric capacity density of the positive electrode mixture is 570 mAh/cm³.

In contrast, in Examples 1 to 3, the volumetric capacity density of the positive electrode mixture is 688 mAh/cm³ because the filling density of the positive electrode mixture is 2.75 g/cm³ and the discharge capacity density is 250 mAh/g or greater. Thus, the volumetric capacity densities of the positive electrode mixtures of Examples 1 to 3 are greater than the volumetric capacity densities of those using lithium iron phosphate or lithium cobalt oxide (LiCoO₂) as the positive electrode active material. The non-aqueous electrolyte secondary battery and the positive electrode according to the present invention may be used as a power source for various applications, such as portable power sources and power sources for automobiles.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application Nos. 2007-058562 filed Mar. 8, 2007, and 2008-006720 filed Jan. 16, 2008, each of which is incorporated herein by reference.

What is claimed is:

1. A non-aqueous electrolyte secondary battery comprising:
a positive electrode having a positive electrode mixture, a negative electrode, and a non-aqueous electrolyte,
the positive electrode mixture containing as a positive electrode active material Li₁₊ₓ(Mn_{y}Ni_{z}Co_{1-y-z})₁₋ₓO₂, where 0<x<0.4, 0<y≦1, and 0≦z≦1, and
the positive electrode mixture having a filling density of from 2.2 g/cm³ to 3.6 g/cm³, and a film thickness of less than 50 μm.

2. The non-aqueous electrolyte secondary according to claim 1, wherein the positive electrode active material has a film thickness of 40 μm or less.

3. The non-aqueous electrolyte secondary according to claim 1, wherein the positive electrode active material has a film thickness of 20 μm or greater.

4. The non-aqueous electrolyte secondary according to claim 2, wherein the positive electrode active material has a film thickness of 20 μm or greater.

5. The non-aqueous electrolyte secondary according to claim 1, wherein the positive electrode active material is Li_{1.20}Mn_{0.54}Ni_{0.13}Co_{0.13}O₂.

6. The non-aqueous electrolyte secondary according to claim 2, wherein the positive electrode active material is Li_{1.20}Mn_{0.54}Ni_{0.13}CO_{0.13}O₂.

7. The non-aqueous electrolyte secondary according to claim 3, wherein the positive electrode active material is Li_{1.20}Mn_{0.54}Ni_{0.13}Co_{0.13}O₂.

8. The non-aqueous electrolyte secondary according to claim 4, wherein the positive electrode active material is Li_{1.20}Mn_{0.54}Ni_{0.13}Co_{0.13}O₂.

9. A positive electrode comprising:
a positive electrode mixture,
the positive electrode mixture containing as a positive electrode active material Li₁₊ₓ(Mn_{y}Ni_{z}Co_{1-y-z})₁₋ₓO₂, where 0<x<0.4, 0<y≦1, and 0≦z≦1, and
the positive electrode mixture having a filling density of from 2.2 g/cm³ to 3.6 g/cm³, and a film thickness of less than 50 μm.
